(19) United States
(12) Patent Application Publication
(10) Pub. No.: US 2024/0047673 A1
(43) Pub. Date: Feb. 8, 2024

(54) NITRATE SALT CATHODE ADDITIVES AND METHODS OF USING AND FORMING THE SAME

(71) Applicant: GM GLOBAL TECHNOLOGY OPERATIONS LLC, Detroit, MI (US)

(72) Inventors: Yifan ZHAO, Warren, MI (US); Xingcheng XIAO, Troy, MI (US)

(73) Assignee: GM GLOBAL TECHNOLOGY OPERATIONS LLC, Detroit, MI (US)

(21) Appl. No.: 17/880,528

(22) Filed: Aug. 3, 2022

(51) Int. Cl. H01M 4/58; H01M 10/0568; H01M 4/505; H01M 4/38; H01M 10/0525; H01M 4/36; H01M 4/525

(52) U.S. Cl. CPC H01M 4/58; H01M 10/0568; H01M 4/505; H01M 4/382; H01M 10/0525; H01M 4/366; H01M 4/525; H01M 10/0569

(57) ABSTRACT

The present disclosure provides an electrochemical cell that cycles lithium ions. The electrochemical cell includes a first electrode including a first electroactive material, a second electrode including a second electroactive material, and a separating layer disposed therebetween. The second electroactive material include a plurality of electroactive material particles, where at least a portion of the electroactive material particles have a surface coating that includes a nitrate salt. The first electroactive material can include a lithium metal, and the electrochemical cell can further include a carbonate-based solvent.

### INTRODUCTION

This section provides background information related to the present disclosure which is not necessarily prior art.

Advanced energy storage devices and systems are in demand to satisfy energy and/or power requirements for a variety of products, including automotive products such as start-stop systems (e.g., 12V start-stop systems), battery-assisted systems, hybrid electric vehicles (“HEVs”), and electric vehicles (“EVs”). Typical lithium-ion batteries include at least two electrodes and an electrolyte and/or separator. One of the two electrodes may serve as a positive electrode or cathode and the other electrode may serve as a negative electrode or anode. A separator filled with a liquid or solid electrolyte may be disposed between the negative and positive electrodes. The electrolyte is suitable for conducting lithium ions between the electrodes and, like the two electrodes, may be in solid and/or liquid form and/or a hybrid thereof. In instances of solid-state batteries, which include solid-state electrodes and a solid-state electrolyte (or solid-state separator), the solid-state electrolyte (or solid-state separator) may physically separate the electrodes so that a distinct separator is not required.

Many different materials may be used to create components for a lithium-ion battery. In certain variations, the negative electrode may include a lithium-containing material, such as metallic lithium, so that the electrochemical cell is considered a lithium metal battery or cell. Lithium-containing materials, like metallic lithium, have various potential advantages, including having the highest theoretical capacity and lowest electrochemical potential. Thus, lithium metal batteries are one of the most promising candidates for high energy storage systems. However, lithium metal batteries also have potential downsides, including possibly exhibiting unreliable or diminished performance and potential premature electrochemical cell failure. For example, side reactions can occur between the metallic lithium and the electrolyte, which undesirably promotes the formation of a solid-electrolyte interface (“SEI”) and/or continuous electrolyte decomposition and/or active lithium consumption. Accordingly, it would be desirable to develop materials for use in high energy lithium-ion batteries that reduce or suppress lithium metal side reactions.

### SUMMARY

This section provides a general summary of the disclosure, and is not a comprehensive disclosure of its full scope or all of its features.

The present disclosure relates to positive electrode additives, to electrodes and electrochemical cells including the same, and to methods of making and using the same.

In various aspects, the present disclosure provides an electroactive material for use with an electrochemical cell that cycles lithium ions. The electroactive material may include a plurality of electroactive material particles, where at least a portion of the electroactive material particles have a surface coating that includes a nitrate salt.

In one aspect, the nitrate salt may be selected from the group consisting of: lithium nitrate (LiNO₃), cesium nitrate (CsNO₃), potassium nitrate (KNO₃), rubidium nitrate (RbNO₃), magnesium nitrate (Mg(NO₃)₂), and combinations thereof.

In one aspect, the at least a portion of the electroactive material particles defining the plurality of electroactive material particles may include a material represented by:

LiM¹ₓM²_{y}M³_{z}M⁴_{(1-x-y-z)}O₂

where M¹, M², M³, and M⁴ are each a transition metal independently selected from the group consisting of: nickel (Ni), manganese (Mn), cobalt (Co), aluminum (Al), iron (Fe), and combinations thereof, 0≤x≤1, 0≤y≤1, and 0≤z≤1.

In one aspect, an average particle size of the electroactive material particles of the plurality of electroactive material particles may be greater than or equal to about 1 micrometer to less than or equal to about 20 micrometers, and the surface coating may have an average thickness greater than or equal to about 0.1 micrometers to less than or equal to about 10 micrometers.

In various aspects, the present disclosure provides an electrochemical cell that cycles lithium ions. The electrochemical cell may include a first electrode that includes a first electroactive material, a second electrode that includes a second electroactive material, and a separating layer disposed between the first electrode and the second electrode. The second electroactive material may include a plurality of electroactive material particles, where at least a portion of the electroactive material particles have a surface coating that includes a nitrate salt.

In one aspect, the nitrate salt may be selected from the group consisting of: lithium nitrate (LiNO₃), cesium nitrate (CsNO₃), potassium nitrate (KNO₃), rubidium nitrate (RbNO₃), magnesium nitrate (Mg(NO₃)₂), and combinations thereof.

In one aspect, a mass loading of the nitrate salt in the surface coating may be greater than or equal to about 0.1 mg/cm² to less than or equal to about 10 mg/cm².

In one aspect, the portion of the electroactive material particles having the surface coating may be distributed evenly throughout the second electrode.

In one aspect, the surface coating may be a continuous coating having an average thickness greater than or equal to about 0.1 micrometer to less than or equal to about 10 micrometers, and an average particle size of the electroactive material particles of the plurality of electroactive material particles may be greater than or equal to about 1 micrometer to less than or equal to about 20 micrometers.

In one aspect, the second electrode may have a plurality of pores and a porosity greater than or equal to about 20 vol. % to less than or equal to about 50 vol. %.

In one aspect, the second electrode may further include an electrolyte that is in contact with the second electroactive material. The electrolyte may include a solvent selected from the group consisting of: ethylene carbonate (EC), propylene carbonate (PC), butylene carbonate (BC), fluoroethylene carbonate (FEC), vinylene carbonate (VC), dimethyl carbonate (DMC), diethyl carbonate (DEC), ethylmethylcarbonate (EMC), and combinations thereof.

In one aspect, the at least a portion of the electroactive material particles defining the plurality of electroactive material particles include a material represented by:

LiM¹ₓM²_{y}M³_{z}M⁴_{(1-x-y-z)}O₂

where M¹, M², M³, and M⁴ are each a transition metal independently selected from the group consisting of: nickel (Ni), manganese (Mn), cobalt (Co), aluminum (Al), iron (Fe), and combinations thereof, 0≤x≤1, 0≤y≤1, and 0≤z≤1.

In one aspect, the first electroactive material may include a lithium metal.

In one aspect, the electrochemical cell may further include an electrolyte that is in contact with the first electroactive material and the second electroactive material. The electrolyte may include a solvent selected from the group consisting of: ethylene carbonate (EC), propylene carbonate (PC), butylene carbonate (BC), fluoroethylene carbonate (FEC), vinylene carbonate (VC), dimethyl carbonate (DMC), diethyl carbonate (DEC), ethylmethylcarbonate (EMC), and combinations thereof.

In various aspects, the present disclosure provides a method of preparing an electroactive material for use with an electrochemical cell that cycles lithium ions. The method may include contacting a plurality of electroactive material particles with a precursor solution that includes greater than or equal to about 0.5 M of a nitrate salt to form an admixture, and drying the admixture to form surface coatings on at least a portion of the electroactive material particles defining the plurality of electroactive material particles.

In one aspect, the nitrate salt may be selected from the group consisting of: lithium nitrate (LiNO₃), cesium nitrate (CsNO₃), potassium nitrate (KNO₃), rubidium nitrate (RbNO₃), magnesium nitrate (Mg(NO₃)₂), and combinations thereof.

In one aspect, the contacting may include immersing the electroactive material particles of the plurality of electroactive material particles in the precursor solution.

In one aspect, the electroactive material particles of the plurality of electroactive material particles may be immersed in the precursor solution for a period greater than or equal to about 1 minute to less than or equal to about 5 hours.

In one aspect, the contacting may include spraying the precursor solution onto exposed surfaces of the electroactive material particles of the plurality of electroactive material particles.

In one aspect, the drying may include a vacuum drying process having a temperature greater than or equal to about 20° C. to less than or equal to about 130° C.

Further areas of applicability will become apparent from the description provided herein. The description and specific examples in this summary are intended for purposes of illustration only and are not intended to limit the scope of the present disclosure.

### BRIEF DESCRIPTION OF THE DRAWINGS

The drawings described herein are for illustrative purposes only of selected embodiments and not all possible implementations, and are not intended to limit the scope of the present disclosure.

FIG. 1 is an illustration of an example electrochemical battery cell including one or more nitrate salt cathode additives in accordance with various aspects of the present disclosure;

FIG. 2 is an illustration of an example positive electroactive material particles including a nitrate salt particle coating in accordance with various aspects of the present disclosure;

FIG. 3 is a graphical illustration demonstrating the impedance of an example cell including one or more nitrate salt cathode additives in accordance with various aspects of the present disclosure;

FIG. 4 is a flowchart illustrating an example method for preparing nitrate salt particle coatings in accordance with various aspects of the present disclosure;

FIG. 5A is a graphical illustration demonstrating the areal capacity of an example cell including one or more nitrate salt cathode additives in accordance with various aspects of the present disclosure; and

FIG. 5B is a graphical illustration demonstrating the capacity retention of an example cell including one or more nitrate salt cathode additives in accordance with various aspects of the present disclosure.

Corresponding reference numerals indicate corresponding parts throughout the several views of the drawings.

### DETAILED DESCRIPTION

Example embodiments are provided so that this disclosure will be thorough, and will fully convey the scope to those who are skilled in the art. Numerous specific details are set forth such as examples of specific compositions, components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, elements, compositions, steps, integers, operations, and/or components, but do not preclude the presence or addition of one or more other features, integers, steps, operations, elements, components, and/or groups thereof. Although the open-ended term “comprising,” is to be understood as a non-restrictive term used to describe and claim various embodiments set forth herein, in certain aspects, the term may alternatively be understood to instead be a more limiting and restrictive term, such as “consisting of” or “consisting essentially of.” Thus, for any given embodiment reciting compositions, materials, components, elements, features, integers, operations, and/or process steps, the present disclosure also specifically includes embodiments consisting of, or consisting essentially of, such recited compositions, materials, components, elements, features, integers, operations, and/or process steps. In the case of “consisting of,” the alternative embodiment excludes any additional compositions, materials, components, elements, features, integers, operations, and/or process steps, while in the case of “consisting essentially of,” any additional compositions, materials, components, elements, features, integers, operations, and/or process steps that materially affect the basic and novel characteristics are excluded from such an embodiment, but any compositions, materials, components, elements, features, integers, operations, and/or process steps that do not materially affect the basic and novel characteristics can be included in the embodiment.

Any method steps, processes, and operations described herein are not to be construed as necessarily requiring their performance in the particular order discussed or illustrated, unless specifically identified as an order of performance. It is also to be understood that additional or alternative steps may be employed, unless otherwise indicated.

When a component, element, or layer is referred to as being “on,” “engaged to,” “connected to,” or “coupled to” another element or layer, it may be directly on, engaged, connected, or coupled to the other component, element, or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various steps, elements, components, regions, layers and/or sections, these steps, elements, components, regions, layers and/or sections should not be limited by these terms, unless otherwise indicated. These terms may be only used to distinguish one step, element, component, region, layer or section from another step, element, component, region, layer, or section. Terms such as “first,” “second,” and other numerical terms when used herein do not imply a sequence or order unless clearly indicated by the context. Thus, a first step, element, component, region, layer, or section discussed below could be termed a second step, element, component, region, layer, or section without departing from the teachings of the example embodiments.

Spatially or temporally relative terms, such as “before,” “after,” “inner,” “outer,” “beneath,” “below,” “lower,” “above,” “upper,” and the like, may be used herein for ease of description to describe one element or feature's relationship to another element(s) or feature(s) as illustrated in the figures. Spatially or temporally relative terms may be intended to encompass different orientations of the device or system in use or operation in addition to the orientation depicted in the figures.

Throughout this disclosure, the numerical values represent approximate measures or limits to ranges to encompass minor deviations from the given values and embodiments having about the value mentioned as well as those having exactly the value mentioned. Other than in the working examples provided at the end of the detailed description, all numerical values of parameters (e.g., of quantities or conditions) in this specification, including the appended claims, are to be understood as being modified in all instances by the term “about” whether or not “about” actually appears before the numerical value. “About” indicates both exactly or precisely the stated numerical value, and also, that the stated numerical value allows some slight imprecision (with some approach to exactness in the value; approximately or reasonably close to the value; nearly). If the imprecision provided by “about” is not otherwise understood in the art with this ordinary meaning, then “about” as used herein indicates at least variations that may arise from ordinary methods of measuring and using such parameters. For example, “about” may comprise a variation of less than or equal to 5%, optionally less than or equal to 4%, optionally less than or equal to 3%, optionally less than or equal to 2%, optionally less than or equal to 1%, optionally less than or equal to 0.5%, and in certain aspects, optionally less than or equal to 0.1%.

In addition, disclosure of ranges includes disclosure of all values and further divided ranges within the entire range, including endpoints and sub-ranges given for the ranges.

Example embodiments will now be described more fully with reference to the accompanying drawings.

The present technology relates to electrochemical cells including one or more nitrate salt cathode additives, and also, to methods of forming and using the same. Such cells can be used in vehicle or automotive transportation applications (e.g., motorcycles, boats, tractors, buses, motorcycles, mobile homes, campers, and tanks). However, the present technology may also be employed in a wide variety of other industries and applications, including aerospace components, consumer goods, devices, buildings (e.g., houses, offices, sheds, and warehouses), office equipment and furniture, and industrial equipment machinery, agricultural or farm equipment, or heavy machinery, by way of non-limiting example. Further, although the illustrated examples detail below include a single positive electrode cathode and a single anode, the skilled artisan will recognize that the present teachings also extend to various other configurations, including those having one or more cathodes and one or more anodes, as well as various current collectors with electroactive layers disposed on or adjacent to one or more surfaces thereof.

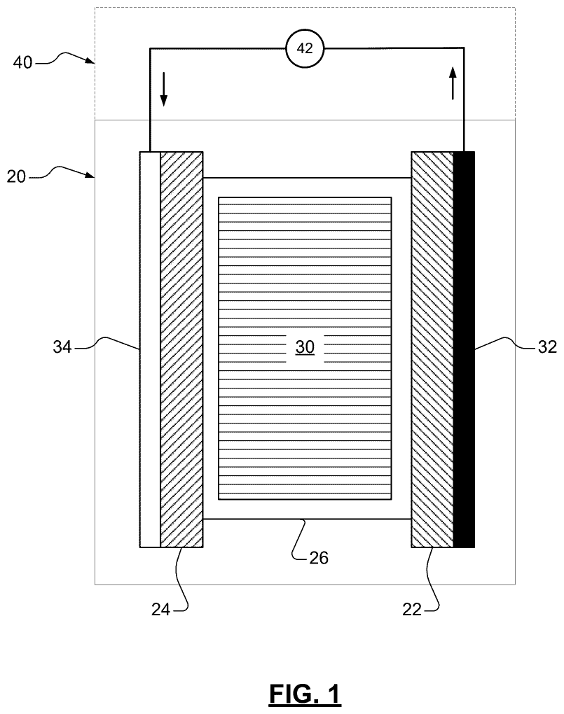

An exemplary and schematic illustration of an electrochemical cell (also referred to as a battery) 20 is shown in FIG. 1. The battery 20 includes a negative electrode 22 (e.g., anode), a positive electrode 24 (e.g., cathode), and a separator 26 disposed between the two electrodes 22, 24. The separator 26 provides electrical separation-prevents physical contact-between the electrodes 22, 24. The separator 26 also provides a minimal resistance path for internal passage of lithium ions, and in certain instances, related anions, during cycling of the lithium ions. In various aspects, the separator 26 comprises an electrolyte 30 that may, in certain aspects, also be present in the negative electrode 22 and/or the positive electrode 24, so as to form a continuous electrolyte network. In certain variations, the separator 26 may be formed by a solid-state electrolyte or a semi-solid-state electrolyte (e.g., gel electrolyte). For example, the separator 26 may be defined by a plurality of solid-state electrolyte particles. In the instance of solid-state batteries and/or semi-solid-state batteries, the positive electrode 24 and/or the negative electrode 22 may include a plurality of solid-state electrolyte particles. The plurality of solid-state electrolyte particles included in, or defining, the separator 26 may be the same as or different from the plurality of solid-state electrolyte particles included in the positive electrode 24 and/or the negative electrode 22.

A first current collector 32 (e.g., a negative current collector) may be positioned at or near the negative electrode 22. The first current collector 32 together with the negative electrode 22 may be referred to as a negative electrode assembly. Although not illustrated, the skilled artisan will appreciate that, in certain variations, negative electrodes 22 (also referred to as negative electroactive material layers) may be disposed on one or more parallel sides of the first current collector 32. Similarly, the skilled artisan will appreciate that, in other variations, a negative electroactive material layer may be disposed on a first side of the first current collector 32, and a positive electroactive material layer may be disposed on a second side of the first current collector 32. In each instance, the first current collector 32 may be a metal foil, metal grid or screen, or expanded metal comprising copper or any other appropriate electrically conductive material known to those of skill in the art.

A second current collector 34 (e.g., a positive current collector) may be positioned at or near the positive electrode 24. The second current collector 34 together with the positive electrode 24 may be referred to as a positive electrode assembly. Although not illustrated, the skilled artisan will appreciate that, in certain variations, positive electrodes 24 (also referred to as positive electroactive material layers) may be disposed on one or more parallel sides of the second current collector 34. Similarly, the skilled artisan will appreciate that, in other variations, a positive electroactive material layer may be disposed on a first side of the second current collector 34, and a negative electroactive material layer may be disposed on a second side of the second current collector 34. In each instance, the second electrode current collector 34 may be a metal foil, metal grid or screen, or expanded metal comprising aluminum or any other appropriate electrically conductive material known to those of skill in the art.

The first current collector 32 and the second current collector 34 may respectively collect and move free electrons to and from an external circuit 40. For example, an interruptible external circuit 40 and a load device 42 may connect the negative electrode 22 (through the first current collector 32) and the positive electrode 24 (through the second current collector 34). The battery 20 can generate an electric current during discharge by way of reversible electrochemical reactions that occur when the external circuit 40 is closed (to connect the negative electrode 22 and the positive electrode 24) and the negative electrode 22 has a lower potential than the positive electrode. The chemical potential difference between the positive electrode 24 and the negative electrode 22 drives electrons produced by a reaction, for example, the oxidation of intercalated lithium, at the negative electrode 22 through the external circuit 40 toward the positive electrode 24. Lithium ions that are also produced at the negative electrode 22 are concurrently transferred through the electrolyte 30 contained in the separator 26 toward the positive electrode 24. The electrons flow through the external circuit 40 and the lithium ions migrate across the separator 26 containing the electrolyte 30 to form intercalated lithium at the positive electrode 24. As noted above, the electrolyte 30 is typically also present in the negative electrode 22 and positive electrode 24. The electric current passing through the external circuit 40 can be harnessed and directed through the load device 42 until the lithium in the negative electrode 22 is depleted and the capacity of the battery 20 is diminished.

The battery 20 can be charged or re-energized at any time by connecting an external power source to the lithium ion battery 20 to reverse the electrochemical reactions that occur during battery discharge. Connecting an external electrical energy source to the battery 20 promotes a reaction, for example, non-spontaneous oxidation of intercalated lithium, at the positive electrode 24 so that electrons and lithium ions are produced. The lithium ions flow back toward the negative electrode 22 through the electrolyte 30 across the separator 26 to replenish the negative electrode 22 with lithium (e.g., intercalated lithium) for use during the next battery discharge event. As such, a complete discharging event followed by a complete charging event is considered to be a cycle, where lithium ions are cycled between the positive electrode 24 and the negative electrode 22. The external power source that may be used to charge the battery 20 may vary depending on the size, construction, and particular end-use of the battery 20. Some notable and exemplary external power sources include, but are not limited to, an AC-DC converter connected to an AC electrical power grid though a wall outlet and a motor vehicle alternator.

In many lithium-ion battery configurations, each of the first current collector 32, negative electrode 22, separator 26, positive electrode 24, and second current collector 34 are prepared as relatively thin layers (for example, from several microns to a fraction of a millimeter or less in thickness) and assembled in layers connected in electrical parallel arrangement to provide a suitable electrical energy and power package. In various aspects, the battery 20 may also include a variety of other components that, while not depicted here, are nonetheless known to those of skill in the art. For instance, the battery 20 may include a casing, gaskets, terminal caps, tabs, battery terminals, and any other conventional components or materials that may be situated within the battery 20, including between or around the negative electrode 22, the positive electrode 24, and/or the separator 26. The battery 20 shown in FIG. 1 includes a liquid electrolyte 30 and shows representative concepts of battery operation. However, the present technology also applies to solid-state batteries and/or semi-solid state batteries that include solid-state electrolytes and/or solid-state electrolyte particles and/or semi-solid electrolytes and/or solid-state electroactive particles that may have different designs as known to those of skill in the art.

The size and shape of the battery 20 may vary depending on the particular application for which it is designed. Battery-powered vehicles and hand-held consumer electronic devices, for example, are two examples where the battery 20 would most likely be designed to different size, capacity, and power-output specifications. The battery 20 may also be connected in series or parallel with other similar lithium-ion cells or batteries to produce a greater voltage output, energy, and power if it is required by the load device 42. Accordingly, the battery 20 can generate electric current to a load device 42 that is part of the external circuit 40. The load device 42 may be powered by the electric current passing through the external circuit 40 when the battery 20 is discharging. While the electrical load device 42 may be any number of known electrically-powered devices, a few specific examples include an electric motor for an electrified vehicle, a laptop computer, a tablet computer, a cellular phone, and cordless power tools or appliances. The load device 42 may also be an electricity-generating apparatus that charges the battery 20 for purposes of storing electrical energy.

With renewed reference to FIG. 1, the positive electrode 24, the negative electrode 22, and the separator 26 may each include an electrolyte solution or system 30 inside their pores, capable of conducting lithium ions between the negative electrode 22 and the positive electrode 24. Any appropriate electrolyte 30, whether in solid, liquid, or gel form, capable of conducting lithium ions between the negative electrode 22 and the positive electrode 24 may be used in the lithium-ion battery 20. For example, in certain aspects, the electrolyte 30 may be a non-aqueous liquid electrolyte solution (e.g., >1 M) that includes a lithium salt dissolved in an organic solvent or a mixture of organic solvents. Numerous conventional non-aqueous liquid electrolyte 30 solutions may be employed in the battery 20.

A non-limiting list of lithium salts that may be dissolved in an organic solvent to form the non-aqueous liquid electrolyte solution include lithium hexafluorophosphate (LiPF₆), lithium perchlorate (LiClO₄), lithium tetrachloroaluminate (LiAlCl₄), lithium iodide (LiI), lithium bromide (LiBr), lithium thiocyanate (LiSCN), lithium tetrafluoroborate (LiBF₄), lithium tetraphenylborate (LiB(C₆H₅)₄), lithium bis(oxalato)borate (LiB(C₂O₄)₂) (LiBOB), lithium difluorooxalatoborate (LiBF₂(C₂O₄)), lithium hexafluoroarsenate (LiAsF₆), lithium trifluoromethanesulfonate (LiCF₃SO₃), lithium bis(trifluoromethane)sulfonylimide (LiN(CF₃SO₂)₂), lithium bis(fluorosulfonyl)imide (LiN(FSO₂)₂) (LiSFI), and combinations thereof. These and other similar lithium salts may be dissolved in a variety of non-aqueous aprotic organic solvents, including but not limited to, various alkyl carbonates, such as cyclic carbonates (e.g., ethylene carbonate (EC), propylene carbonate (PC), butylene carbonate (BC), fluoroethylene carbonate (FEC), vinylene carbonate (VC), and the like), linear carbonates (e.g., dimethyl carbonate (DMC), diethyl carbonate (DEC), ethylmethylcarbonate (EMC), and the like), aliphatic carboxylic esters (e.g., methyl formate, methyl acetate, methyl propionate, and the like), γ-lactones (e.g., γ-butyrolactone, γ-valerolactone, and the like), chain structure ethers (e.g., 1,2-dimethoxyethane, 1-2-diethoxyethane, ethoxymethoxyethane, and the like), cyclic ethers (e.g., tetrahydrofuran, 2-methyltetrahydrofuran, 1,3-dioxolane, and the like), sulfur compounds (e.g., sulfolane), and combinations thereof.

The porous separator 26 may include, in certain instances, a microporous polymeric separator including a polyolefin. The polyolefin may be a homopolymer (derived from a single monomer constituent) or a heteropolymer (derived from more than one monomer constituent), which may be either linear or branched. If a heteropolymer is derived from two monomer constituents, the polyolefin may assume any copolymer chain arrangement, including those of a block copolymer or a random copolymer. Similarly, if the polyolefin is a heteropolymer derived from more than two monomer constituents, it may likewise be a block copolymer or a random copolymer. In certain aspects, the polyolefin may be polyethylene (PE), polypropylene (PP), or a blend of polyethylene (PE) and polypropylene (PP), or multi-layered structured porous films of PE and/or PP. Commercially available polyolefin porous separator membranes 26 include CELGARD® 2500 (a monolayer polypropylene separator) and CELGARD® 2320 (a trilayer polypropylene/polyethylene/polypropylene separator) available from Celgard LLC.

When the separator 26 is a microporous polymeric separator, it may be a single layer or a multi-layer laminate, which may be fabricated from either a dry or a wet process. For example, in certain instances, a single layer of the polyolefin may form the entire separator 26. In other aspects, the separator 26 may be a fibrous membrane having an abundance of pores extending between the opposing surfaces and may have an average thickness of less than a millimeter, for example. As another example, however, multiple discrete layers of similar or dissimilar polyolefins may be assembled to form the microporous polymer separator 26. The separator 26 may also comprise other polymers in addition to the polyolefin such as, but not limited to, polyethylene terephthalate (PET), polyvinylidene fluoride (PVdF), a polyamide, polyimide, poly(amide-imide) copolymer, polyetherimide, and/or cellulose, or any other material suitable for creating the required porous structure. The polyolefin layer, and any other optional polymer layers, may further be included in the separator 26 as a fibrous layer to help provide the separator 26 with appropriate structural and porosity characteristics.

In certain aspects, the separator 26 may further include one or more of a ceramic material and a heat-resistant material. For example, the separator 26 may also be admixed with the ceramic material and/or the heat-resistant material, or one or more surfaces of the separator 26 may be coated with the ceramic material and/or the heat-resistant material. In certain variations, the ceramic material and/or the heat-resistant material may be disposed on one or more sides of the separator 26. The ceramic material may be selected from the group consisting of: alumina (Al₂O₃), silica (SiO₂), and combinations thereof. The heat-resistant material may be selected from the group consisting of: Nomex, Aramid, and combinations thereof.

Various conventionally available polymers and commercial products for forming the separator 26 are contemplated, as well as the many manufacturing methods that may be employed to produce such a microporous polymer separator 26. In each instance, the separator 26 may have an average thickness greater than or equal to about 1 micrometer (μm) to less than or equal to about 50 μm, and in certain instances, optionally greater than or equal to about 1 μm to less than or equal to about 20 μm.

In various aspects, the porous separator 26 and/or the electrolyte 30 disposed in the porous separator 26 as illustrated in FIG. 1 may be replaced with a solid-state electrolyte (“SSE”) and/or semi-solid-state electrolyte (e.g., gel) that functions as both an electrolyte and a separator. For example, the solid-state electrolyte and/or semi-solid-state electrolyte may be disposed between the positive electrode 24 and negative electrode 22. The solid-state electrolyte and/or semi-solid-state electrolyte facilitates transfer of lithium ions, while mechanically separating and providing electrical insulation between the negative and positive electrodes 22, 24. By way of non-limiting example, the solid-state electrolyte and/or semi-solid-state electrolyte may include a plurality of fillers, such as LiTi₂(PO₄)₃, LiGe₂(PO₄)₃, Li₇La₃Zr₂O₁₂, Li₃xLa_{2/3}−xTiO₃, Li₃PO₄, Li₃N, Li₄GeS₄, Li₁₀GeP₂S₁₂, Li₂S—P₂S₅, Li₆PS₅Cl, Li₆PS₅Br, Li₆PS₅I, Li₃OCl, Li_{2.99} Ba_{0.005}ClO, or combinations thereof. The semi-solid-state electrolyte may include a polymer host and a liquid electrolyte. The polymer host may include, for example, polyvinylidene fluoride (PVDF), polyvinylidene fluoride-hexafluoropropylene (PVDF-HFP), polyethylene oxide (PEO), polypropylene oxide (PPO), polyacrylonitrile (PAN), polymethacrylonitrile (PMAN), polymethyl methacrylate (PMMA), carboxymethyl cellulose (CMC), poly(vinyl alcohol) (PVA), polyvinylpyrrolidone (PVP), and combinations thereof. In certain variations, the semi-solid or gel electrolyte may also be found in the positive electrode 24 and/or the negative electrodes 22.

The negative electrode (which can also be referred to as a negative electroactive material layer) 22 is formed from a lithium host material that is capable of functioning as a negative terminal of a lithium-ion battery. In various aspects, the negative electrode 22 may be defined by a plurality of negative electroactive material particles. Such negative electroactive material particles may be disposed in one or more layers so as to define the three-dimensional structure of the negative electrode 22. The electrolyte 30 may be introduced, for example after cell assembly, and contained within pores of the negative electrode 22. For example, in certain variations, the negative electrode 22 may include a plurality of solid-state electrolyte particles. In each instance, the negative electrode 22 (including the one or more layers) may have a thickness greater than or equal to about 0 nm to less than or equal to about 500 μm, optionally greater than or equal to about 1 μm to less than or equal to about 500 μm, and in certain aspects, optionally greater than or equal to about 10 μm to less than or equal to about 200 μm.

In various aspects, negative electrode 22 may include a lithium-containing negative electroactive material, such as a lithium alloy and/or a lithium metal. For example, in certain variations, the negative electrode 22 may be defined by a lithium metal foil. In other variations, the negative electrode 22 may include, for example only, carbonaceous negative electroactive materials (such as, graphite, hard carbon, soft carbon, and the like) and/or metallic negative electroactive materials (such as tin, aluminum, magnesium, germanium, and alloys thereof, and the like). In further variations, the negative electrode 22 may include a silicon-based negative electroactive material. In still further variations, the negative electrode 22 may be a composite electrode including a combination of negative electroactive materials. For example, the negative electrode 22 may include a first negative electroactive material and a second negative electroactive material. In certain variations, a ratio of the first negative electroactive material to the second negative electroactive material may be greater than or equal to about 5:95 to less than or equal to about 95:5. The first negative electroactive material may be a volume-expanding negative electroactive material including, for example, silicon, aluminum, germanium, and/or tin. The second negative electroactive material may include a carbonaceous negative electroactive material (e.g., graphite, hard carbon, and/or soft carbon). For example, in certain variations, the negative electroactive material may include a carbonaceous-silicon based composite including, for example, about 10 wt. % SiOₓ (where 0≤x≤2) and about 90 wt. % graphite. In each instance, the negative electroactive material may be prelithiated.

In certain variations, the negative electroactive material may be optionally intermingled (e.g., slurry casted) with an electronically conductive material (i.e. conductive additive) that provide an electron conductive path and/or a polymeric binder material that improve the structural integrity of the negative electrode 22. For example, the negative electrode 22 may include greater than or equal to about 30 wt. % to less than or equal to about 98 wt. %, and in certain aspects, optionally greater than or equal to about 60 wt. % to less than or equal to about 95 wt. %, of the negative electroactive material; greater than or equal to 0 wt. % to less than or equal to about 30 wt. %, and in certain aspects, optionally greater than or equal to about 0.5 wt. % to less than or equal to about 10 wt. %, of the electronically conducting material; and greater than or equal to 0 wt. % to less than or equal to about 20 wt. %, and in certain aspects, optionally greater than or equal to about 0.5 wt. % to less than or equal to about 10 wt. %, of the polymeric binder.

Example polymeric binders include polyimide, polyamic acid, polyamide, polysulfone, polyvinylidene difluoride (PVdF), polytetrafluoroethylene (PTFE), polyacrylic acid (PAA), blends of polyvinylidene fluoride and polyhexafluoropropene, polychlorotrifluoroethylene, ethylene propylene diene monomer (EPDM) rubber, carboxymethyl cellulose (CMC), nitrile butadiene rubber (NBR), styrene-butadiene rubber (SBR), lithium polyacrylate (LiPAA), sodium polyacrylate (NaPAA), sodium alginate, and/or lithium alginate. Electronically conducting materials may include, for example, carbon-based materials, powdered nickel or other metal particles, or conductive polymers. Carbon-based materials may include, for example, particles of graphite, acetylene black (such as KETCHEN™ black or DENKA™ black), carbon nanofibers and nanotubes (e.g., single wall carbon nanotubes (SWCNT), multiwall carbon nanotubes (MWCNT)), graphene (e.g., graphene platelets (GNP), oxidized graphene platelets), conductive carbon blacks (such as, SuperP (SP)), and the like. Examples of a conductive polymer include polyaniline, polythiophene, polyacetylene, polypyrrole, and the like.

The positive electrode 24 is formed from a lithium-based active material that is capable of undergoing lithium intercalation and deintercalation, alloying and dealloying, or plating and stripping, while functioning as the positive terminal of a lithium-ion battery. The positive electrode 24 can be defined by a plurality of electroactive material particles. Such positive electroactive material particles may be disposed in one or more layers so as to define the three-dimensional structure of the positive electrode 24. The electrolyte 30 may be introduced, for example after cell assembly, and contained within pores of the positive electrode 24. In certain variations, the positive electrode 24 may include a plurality of solid-state electrolyte particles. In each instance, the positive electrode 24 may have an average thickness greater than or equal to about 1 μm to less than or equal to about 500 μm, and in certain aspects, optionally greater than or equal to about 10 μm to less than or equal to about 200 μm.

In various aspects, the positive electrode 24 may be a nickel-rich cathode including a positive electroactive material represented by:

LiM¹ₓM²_{y}M³_{z}M⁴_{(1-x-y-z)}O₂

where M¹, M², M³, and M⁴ are each a transition metal (for example, each is independently selected from the group consisting of: nickel (Ni), manganese (Mn), cobalt (Co), aluminum (Al), iron (Fe), and combinations thereof), where 0≤x≤1, 0≤y≤1, and 0≤z≤1. For example, the positive electrode 24 may include NMC (LiNiₓCo_{y}Mn_{1-x-y}O₂, where 0.6≤x≤, 0≤y≤0.4) and/or NCA (LiNiₓCo_{y}Al_{1-x-y}O₂, where 0.6≤x≤1, 0≤y≤0.4) and/or NCMA (LiNiₓCo_{y}Mn_{z}Al_{1-x-y-z}O₂, where 0.6≤x≤1, 0≤y≤0.4, 0≤z≤0.4).

In other variations, the positive electrode 24 may include one or more positive electroactive materials having a spinel structure (such as, lithium manganese oxide (Li₍₁₊ₓ₎Mn₂O₄, where 0.1≤x≤1) (LMO) and/or lithium manganese nickel oxide (LiMn₍₂₋ₓ₎NiₓO₄, where 0≤x≤0.5) (LNMO) (e.g., LiMn_{1.5}Ni_{0.5}O₄)); one or more materials with a layered structure (such as, lithium cobalt oxide (LiCoO₂) (LCO)); and/or a lithium iron polyanion oxide with olivine structure (such as, lithium iron phosphate (LiFePO₄) (LFP), lithium manganese-iron phosphate (LiMn₂₋ₓFeₓPO₄, where 0<x<0.3) (LMFP), and/or lithium iron fluorophosphate (Li₂FePO₄F)).

In still other variations, the positive electrode 24 may be a composite electrode including two or more positive electroactive material. For example, the positive electrode 24 may include a first positive electroactive material and a second positive electroactive material. In certain variations, a ratio of the first positive electroactive material to the second positive electroactive material may be greater than or equal to about 1:9 to less than or equal to about 9:1. The first positive electroactive material may include the nickel-rich positive electroactive material. The second positive electroactive material may include, for example, a layered oxide represented by LiMeO₂, where Me is a transition metal, such as cobalt (Co), nickel (Ni), manganese (Mn), iron (Fe), aluminum (Al), vanadium (V), or combinations thereof; an olivine-type oxide represented by LiMePO₄, where Me is a transition metal, such as cobalt (Co), nickel (Ni), manganese (Mn), iron (Fe), aluminum (Al), vanadium (V), or combinations thereof; a monoclinic-type oxide represented by Li₃Me₂(PO₄)₃, where Me is a transition metal, such as cobalt (Co), nickel (Ni), manganese (Mn), iron (Fe), aluminum (Al), vanadium (V), or combinations thereof; a spinel-type oxide represented by LiMe₂O₄, where Me is a transition metal, such as cobalt (Co), nickel (Ni), manganese (Mn), iron (Fe), aluminum (Al), vanadium (V), or combinations thereof; and/or a tavorite represented by LiMeSO₄F and/or LiMePO₄F, where Me is a transition metal, such as cobalt (Co), nickel (Ni), manganese (Mn), iron (Fe), aluminum (Al), vanadium (V), or combinations thereof.

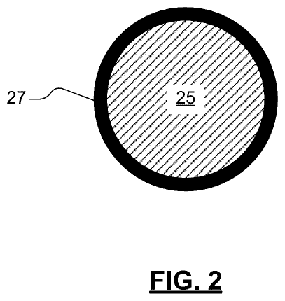

In each variation, the positive electrode 24 includes a nitrate salt. For example, the positive electrode 24 may include greater than or equal to about 0.1 wt. % to less than or equal to about 10 wt. %, and in certain aspects, optionally greater than or equal to about 0.5 wt. % to less than or equal to about 5 wt. %, of the nitrate salt. A mass loading of the nitrate salt in the positive electrode 24 may be greater than or equal to about 0.1 mg/cm² to less than or equal to about 10 mg/cm², and in certain aspects, optionally greater than or equal to about 0.1 mg/cm² to less than or equal to about 5 mg/cm². The nitrate salt may include, for example, lithium nitrate (LiNO₃), cesium nitrate (CsNO₃), potassium nitrate (KNO₃), rubidium nitrate (RbNO₃), and/or magnesium nitrate (Mg(NO₃)₂) and be distributed uniformly, horizontally and vertically, within the positive electrode 24. For example, in certain variations, as illustrated in FIG. 2, the nitrate salt may form particle coatings 27 on the positive electroactive material particles 25 that define the positive electrode 24.

In certain variations, the positive electroactive material particles 25 may have average particle sizes greater than or equal to about 1 μm to less than or equal to about 20 μm, and in certain aspects, optionally greater than or equal to about 5 μm to less than or equal to about 15 μm, and the particle coatings 27 may have average thicknesses greater than or equal to about 0.1 μm to less than or equal to about 20 μm, and in certain aspects, optionally greater than or equal to about 1 μm to less than or equal to about 10 μm. In certain variations, the particle coatings 27 may be substantially continuous coating covering greater than or equal to about 85%, optionally greater than or equal to about 90%, optionally greater than or equal to about 95%, optionally greater than or equal to about 98%, optionally greater than or equal to about 99%, and in certain aspects, optionally greater than or equal to about 99.% %, of a total exposed surface of each positive electroactive material particle 25.

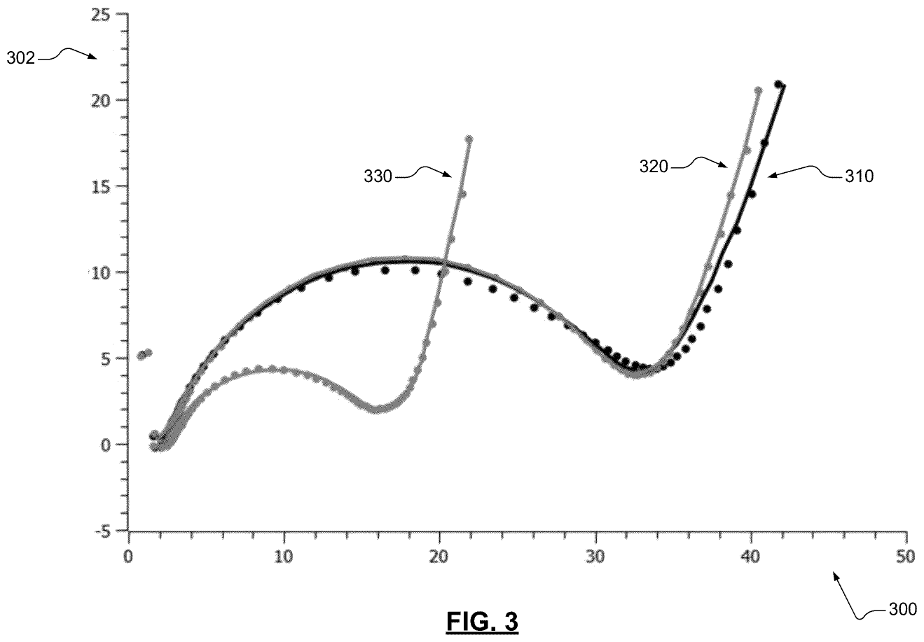

Importantly, the nitrate salt does not compromise the conductivity of the positive electroactive material. For example, by way of example, FIG. 3 charts the impedance of a first example positive electrode 310 including, for example, only NMC, a second example positive electrode 320 including, for example, NMC and dimethoxyethane, and a third example positive electrode 330 including, for example, NMC, dimethoxyethane, and lithium nitrate (LiNO₃), where the x-axis 300 represents ReZ (Ohm), and the γ-axis 302 represents -ImZ (Ohm). As illustrated, the example 330 including the lithium nitrate (LiNO₃) has a reduced impedance as compared to the examples 310, 320, at least in part because the particle coating 27 (e.g., cathode electrolyte interphase (CEI)) has a greater ionic conductivity. For example, the ionic conductivity of the particle coating 27 may be greater than or equal to about 10⁻³ S/cm to less than or equal to about 10⁻⁶ S/cm.

With renewed reference the FIG. 1, the positive electrode 24 including the nitrate additive salt still has a porosity greater than or equal to about 20 vol. % to less than or equal to about 50 vol. %, such that that positive electrode 24 continues to accommodate the electrolyte 30. The nitrate additive salts have a reduced solubility (e.g., about 10⁻⁵ g/mL) in carbonate-based electrolytes, which often causes such nitrate additive salts to be consumed quickly during cathode-electrolyte interphase (“CEI”) and/or solid-electrolyte interphase (“SEI”) layer formation. Incorporating the nitrate additive salts as particle coatings 27 in the positive electrode 24 allows the nitrate additive salts to be slowly released into (e.g., dissolved in) the electrolyte 30 (e.g., carbonate-based electrolyte) during battery operation (for example, as a result of the low solubility of the nitrate salt in the electrolyte 30 and/or the consumption of the one or more additives during cycling), which provides longer term stabilization of any as-formed cathode-electrolyte interphase (“CEI”) as formed on a surface of the positive electrode 24 and/or solid-electrolyte interphase (“SEI”) layer (not shown) as formed on, for example, one or more lithium plated surfaces (e.g., one or more surfaces of the negative electrode current collector 32 and/or one or more surfaces of the negative electrode 22).

In various aspects, the present disclosure provides method for forming the particle coating 27. For example, in certain variations, the nitrate salt may be included with the positive electroactive material particles and other electrode materials (e.g., conductive additive and/or binder) in slurry and disposed (e.g., casted and dried) on the positive electrode current collector 34. The nitrate salt may have a concentration greater than or equal to about 0.1 M in the electrode slurry.

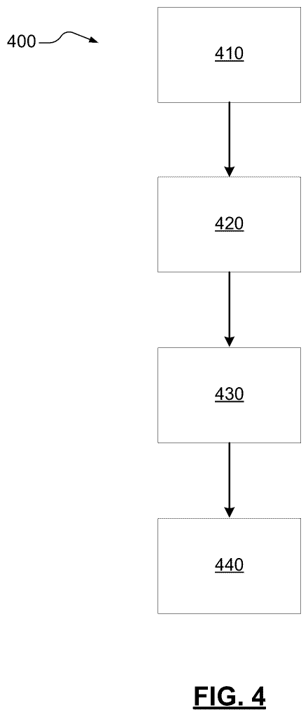

In other variations, as illustrated in FIG. 4, an example method 400 for forming nitrate salt particle coating on positive electroactive material particles may include contacting 430 a precursor solution with the positive electroactive material particles to form an admixture. The positive electroactive material particles may be in the form of a positive electrode (also referred to as a positive electroactive material layer) (i.e., positive electrode 24) disposed near or adjacent to a surface of a positive electrode current collector (i.e., positive electrode current collector 34). In certain variations, the method 400 may include forming the positive electrode 24 by disposing the positive electroactive material particles near or adjacent to a surface of a positive electrode current collector 34.

In various aspects, the contacting 430 may include immersing the positive electroactive material particles (or the positive electrode) into the precursor solution. When the contacting 430 includes immersing the positive electroactive material particles (or the positive electrode) into the precursor solution, the positive electroactive material particles (or the positive electrode) may be immerged in the precursor solution for greater than or equal to about 1 minute to less than or equal to about 5 hours. In other variations, the contacting 430 may include spraying the precursor solution onto exposed surfaces of the positive electroactive material particles (or onto an exposed surface of the positive electrode). In each instance, the precursor solution may be an aqueous or non-aqueous solution including the nitrate salt (e.g., lithium nitrate (LiNO₃), cesium nitrate (CsNO₃), potassium nitrate (KNO₃), rubidium nitrate (RbNO₃), and/or magnesium nitrate (Mg(NO₃)₂) and having a salt concentrating greater than or equal to about 0.5 M. In certain variations the solvent may include dimethoxyethane, organophosphates, dimethyl sulfoxide (DMSO), dimethylacetamide (DMA), and/or N-methyl-2-pyrrolidone (NMP). In certain variations, the method 300 may include preparing 420 the precursor solution, for example, by contacting the nitrate salt to the solvent. Preparing 420 the precursor solution and preparing the positive electrode may occur concurrently or consecutively, as illustrated.

The method 400 may further include removing 440 the solvent form the admixture to precipitate the nitrate salt and form the nitrate salt particle coating on positive electroactive material particles. In certain variations, the removing 440 may include a vacuum drying process having a temperature greater than or equal to about 20° C. to less than or equal to about 130° C. over a period greater than or equal to about 1 hour to less than or equal to about 24 hours.

With renewed reference to FIG. 1, in certain variations, the positive electroactive material may be optionally intermingled (e.g., slurry casted) with an electronically conductive material (i.e. conductive additive) that provide an electron conductive path and/or a polymeric binder material that improve the structural integrity of the positive electrode 24. For example, the positive electrode 24 may include greater than or equal to about 30 wt. % to less than or equal to about 98 wt. %, and in certain aspects, optionally greater than or equal to about 60 wt. % to less than or equal to about 97 wt. %, of the positive electroactive material; greater than or equal to 0 wt. % to less than or equal to about 30 wt. %, and in certain aspects, optionally greater than or equal to about 0.5 wt. % to less than or equal to about 10 wt. %, of the electronically conducting material; and greater than or equal to 0 wt. % to less than or equal to about 20 wt. %, and in certain aspects, optionally greater than or equal to about 0.5 wt. % to less than or equal to about 10 wt. %, of the polymeric binder. The conductive additive and/or binder material as included in the positive electrode 24 may be the same as or different from the conductive additive and/or binder material as included in the negative electrode 22.

Certain features of the current technology are further illustrated in the following non-limiting examples.

### Example 1

Example batteries and battery cells may be prepared in accordance with various aspects of the present disclosure. For example, an example cell 510 may include a positive electrode including the nitrate salt (e.g., lithium nitrate (LiNO₃ at mass loading of about 0.3 mg/cm²)), a dimethoxyethane solvent, and positive electroactive material particles including, for example, NMC622. A first comparative cell 520 may include a positive electrode including only the dimethoxyethane solvent and the positive electroactive material particles including, for example, NMC622. A second comparative cell 530 may include a positive electrode including only the positive electroactive material particles including, for example, NMC622. The example cell 510 and also each of the comparative cells 520, 530 may each include an electrolyte including, for example, include lithium hexafluorophosphate (LiPF₆) and fluoroethylene carbonate (FEC) and dimethyl carbonate (DMC). The example cell 510 and also each of the comparative cells 520, 530 may each be cycled C/10 at greater than or equal to about 3 V to less than or equal to about 4.3 V for the first two cycles, while being charged at C/5 and discharged at C/2 for the remaining cycles.

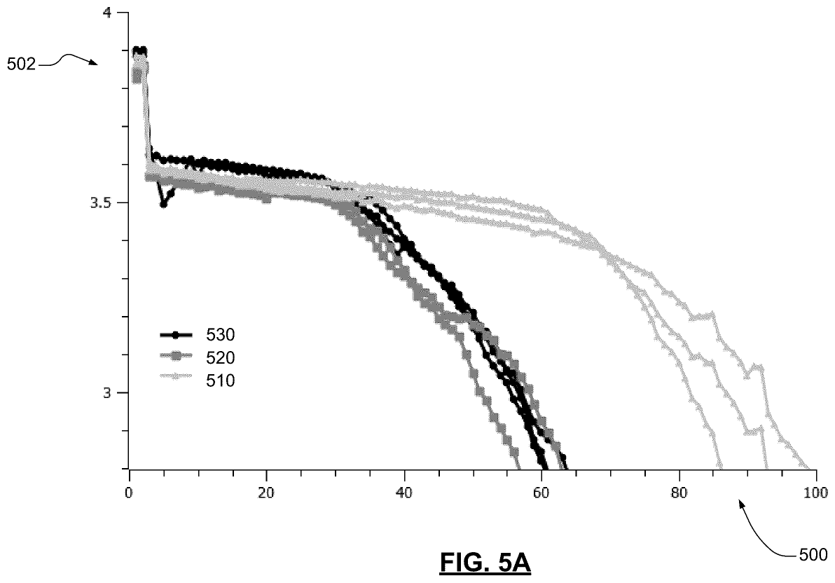

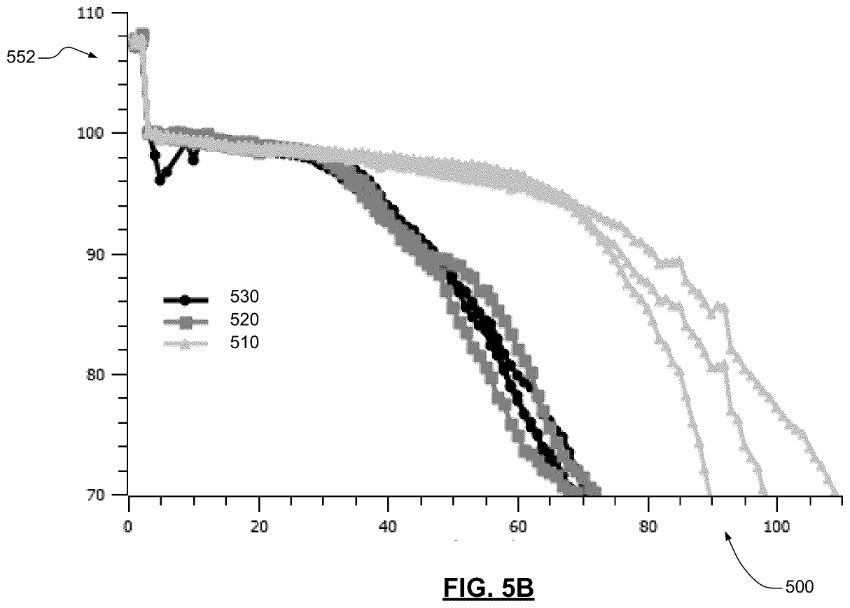

FIG. 5A is a graphical illustration demonstrating the areal capacity of an example cell 510 as compared to the comparative cells 520, 530, where the x-axis 400 represents cycle number, and the y-axis 502 represents areal capacity (mAh/cm²).

FIG. 5B is a graphical illustration demonstrating the capacity retention of an example cell 510 as compared to the comparative cells 520, 530, where the x-axis 550 represents cycle number, and the y-axis 552 represents capacity retention (%)

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. An electroactive material for use with an electrochemical cell that cycles lithium ions, the electroactive material comprising:
a plurality of electroactive material particles, at least a portion of the electroactive material particles having a surface coating comprising a nitrate salt.

2. The electroactive material of claim 1, wherein the nitrate salt is selected from the group consisting of: lithium nitrate (LiNO₃), cesium nitrate (CsNO₃), potassium nitrate (KNO₃), rubidium nitrate (RbNO₃), magnesium nitrate (Mg(NO₃)₂), and combinations thereof.

3. The electroactive material of claim 1, wherein the at least a portion of the electroactive material particles defining the plurality of electroactive material particles comprise a material represented by:
LiM¹ₓM²_{y}M³_{z}M⁴_{(1-x-y-z)}O₂
where M¹, M², M³, and M⁴ are each a transition metal independently selected from the group consisting of: nickel (Ni), manganese (Mn), cobalt (Co), aluminum (Al), iron (Fe), and combinations thereof, 0≤x≤1, 0≤y≤1, and 0≤z≤1.

4. The electroactive material of claim 1, wherein an average particle size of the electroactive material particles of the plurality of electroactive material particles is greater than or equal to about 1 micrometer to less than or equal to about 20 micrometers, and the surface coating has an average thickness greater than or equal to about 0.1 micrometers to less than or equal to about 10 micrometers.

5. An electrochemical cell that cycles lithium ions, the electrochemical cell comprising:
a first electrode comprising a first electroactive material;
a second electrode comprising a second electroactive material, the second electroactive material comprising a plurality of electroactive material particles, at least a portion of the electroactive material particles having a surface coating comprising a nitrate salt; and
a separating layer disposed between the first electrode and the second electrode.

6. The electrochemical cell of claim 5, wherein the nitrate salt is selected from the group consisting of: lithium nitrate (LiNO₃), cesium nitrate (CsNO₃), potassium nitrate (KNO₃), rubidium nitrate (RbNO₃), magnesium nitrate (Mg(NO₃)₂), and combinations thereof.

7. The electrochemical cell of claim 5, wherein a mass loading of the nitrate salt in the surface coating is greater than or equal to about 0.1 mg/cm² to less than or equal to about 10 mg/cm².

8. The electrochemical cell of claim 5, wherein the portion of the electroactive material particles having the surface coating are distributed evenly throughout the second electrode.

9. The electrochemical cell of claim 5, wherein the surface coating is a continuous coating having an average thickness greater than or equal to about 0.1 micrometer to less than or equal to about 10 micrometers, and an average particle size of the electroactive material particles of the plurality of electroactive material particles is greater than or equal to about 1 micrometer to less than or equal to about 20 micrometers.

10. The electrochemical cell of claim 5, wherein the second electrode has a plurality of pores and a porosity greater than or equal to about 20 vol. % to less than or equal to about 50 vol. %.

11. The electrochemical cell of claim 5, wherein the second electrode further comprises an electrolyte that is in contact with the second electroactive material, the electrolyte comprising a solvent selected from the group consisting of: ethylene carbonate (EC), propylene carbonate (PC), butylene carbonate (BC), fluoroethylene carbonate (FEC), vinylene carbonate (VC), dimethyl carbonate (DMC), diethyl carbonate (DEC), ethylmethylcarbonate (EMC), and combinations thereof.

12. The electrochemical cell of claim 5, wherein the at least a portion of the electroactive material particles defining the plurality of electroactive material particles comprise a material represented by:
LiM¹ₓM²_{y}M³_{z}M⁴_{(1-x-y-z)}O₂
where M¹, M², M³, and M⁴ are each a transition metal independently selected from the group consisting of: nickel (Ni), manganese (Mn), cobalt (Co), aluminum (Al), iron (Fe), and combinations thereof, 0≤x≤1, 0≤y≤1, and 0≤z≤1.

13. The electrochemical cell of claim 5, wherein the first electroactive material comprises a lithium metal.

14. The electrochemical cell of claim 13, further comprising an electrolyte that is in contact with the first electroactive material and the second electroactive material, the electrolyte comprising a solvent selected from the group consisting of: ethylene carbonate (EC), propylene carbonate (PC), butylene carbonate (BC), fluoroethylene carbonate (FEC), vinylene carbonate (VC), dimethyl carbonate (DMC), diethyl carbonate (DEC), ethylmethylcarbonate (EMC), and combinations thereof.

15. A method of preparing an electroactive material for use with an electrochemical cell that cycles lithium ions, the method comprising:
contacting a plurality of electroactive material particles with a precursor solution comprising greater than or equal to about 0.5 M of a nitrate salt to form an admixture; and
drying the admixture to form surface coatings on at least a portion of the electroactive material particles defining the plurality of electroactive material particles.

16. The method of claim 15, wherein the nitrate salt is selected from the group consisting of: lithium nitrate (LiNO₃), cesium nitrate (CsNO₃), potassium nitrate (KNO₃), rubidium nitrate (RbNO₃), magnesium nitrate (Mg(NO₃)₂), and combinations thereof.

17. The method of claim 15, wherein the contacting comprises immersing the electroactive material particles of the plurality of electroactive material particles in the precursor solution.

18. The method of claim 17, wherein the electroactive material particles of the plurality of electroactive material particles are immersed in the precursor solution for a period greater than or equal to about 1 minute to less than or equal to about 5 hours.

19. The method of claim 15, wherein the contacting comprises spraying the precursor solution onto exposed surfaces of the electroactive material particles of the plurality of electroactive material particles.

20. The method of claim 15, wherein the drying comprises a vacuum drying process having a temperature greater than or equal to about 20° C. to less than or equal to about 130° C.
